(19) United States
(12) Patent Application Publication
(10) Pub. No.: US 2026/0165296 A1
(43) Pub. Date: Jun. 18, 2026

(54) PET WATER DISPENSER

(71) Applicant: Guangdong Beizhi Technology Co., Ltd., Dongguan (CN)

(72) Inventors: liang LI, Ningbo (CN); Xiushan WEI, Suzhou (CN); Tangtang GU, Zhuhai (CN)

(21) Appl. No.: 19/536,128

(22) Filed: Feb. 10, 2026

(30) Foreign Application Priority Data
Sep. 8, 2025 (CN) 202511270931.8

(51) Int. Cl. A01K 7/02; A01K 5/02; A01K 7/00; A01K 7/04

(52) U.S. Cl. CPC A01K 7/02; A01K 5/0225; A01K 7/00; A01K 7/025; A01K 7/04

(57) ABSTRACT

A pet water dispenser provided, including a bottom base with a mounting cavity and a containment section mounted on said bottom base for containing drinking water; a water agitation assembly is positioned within said containment section and submerged below the water surface; The mounting cavity houses a drive assembly for operating the water agitation assembly, with the mounting cavity spatially isolating the drive assembly from the drinking water within the containment section. The provided pet water dispenser achieves greater water flow agitation with a simpler, more reliable mechanical structure and lower failure rate. Additionally, it offers enhanced functionality: beyond water agitation, features like water agitation discs improve interactivity with pets, increasing their attraction to the device and further promoting water intake.

### CROSS REFERENCE TO RELATED APPLICATIONS

This application claims foreign priority of Chinese Patent Application No. 202511270931.8, filed on Sep. 8, 2025 in the China National Intellectual Property Administration, the disclosures of all of which are hereby incorporated by reference.

### TECHNICAL FIELD

The present disclosure relates to the technical field of pet supplies, specifically to a pet water dispenser.

### BACKGROUND

With socioeconomic development and rising living standards, an increasing number of households are keeping pets. The pet economy's share of the consumer market continues to grow, driving sustained expansion in market scale. Currently, the market offers various pet watering devices. Their fundamental function is to store and supply drinking water for pets, with optimized designs addressing the preference of certain animals, such as cats, for flowing water. Most of these devices utilize methods like circulating pumps or mechanical agitation to keep water moving or create ripples, simulating the effect of fresh, flowing water. This approach aims to stimulate pets' interest in drinking, thereby increasing their water intake.

However, existing pet watering products still exhibit the following major shortcomings in water disturbance: First, most rely on water pumps for circulation, resulting in limited disturbance intensity and relatively complex mechanical structures with higher failure rates. Second, these products generally offer limited functionality, capable only of simple water disturbance. This restricts their long-term appeal to pets, offering low interactivity and entertainment value, and thus providing limited effectiveness in promoting pet hydration.

### SUMMARY

The present disclosure provides a pet water dispenser designed to overcome the limitations of current models, which include restricted water agitation, complex structures, and limited appeal to pets.

According to some embodiments of the present disclosure, a pet water dispenser is provided, including: a bottom base with a mounting cavity; a containment section mounted on said bottom base for containing drinking water; a water agitation assembly, positioned within said containment section and submerged below the water surface; the mounting cavity houses a drive assembly for driving the water agitation assembly, and the mounting cavity spatially isolates the drive assembly from the drinking water within the containment section.

Furthermore, the water agitation assembly includes an agitation base and a water agitation disc for agitating the water body, and the agitation base is directly driven by the drive assembly to induce water movement, while the water agitation disc is indirectly driven by the water body agitated by the agitation base.

Furthermore, the drive assembly includes a magnetic drive component, and the agitation base is mounted with a transmission assembly, which includes a magnetic driven component capable of interacting with the magnetic drive component; and
the drive assembly drives the magnetic driven component to move via the magnetic drive component, thereby driving the agitation base.

Furthermore, the water agitation disc is provided with a central hole, and the agitation base includes a flow guide section for directing water flow, and the flow guide section is mounted through the central hole, with a gap between the flow guide section and the edge of the central hole for water passage; and the flow guide section is connected to a vortex turntable positioned above the water agitation disc, and is connected to a bottom baffle positioned below the water agitation disc; the vortex turntable rotates to guide the water flow into the flow guide section, which directs the water flow through the central hole to the area below the water agitation disc.

Furthermore, a gap for water flow is provided between the edge of the water agitation disc and the containment section.

Furthermore, the vortex turntable is provided with agitation fin plates for guiding water flow to converge toward the vortex turntable; and the vortex turntable is provided with vortex holes, and the flow guide section is provided with flow guide grooves corresponding to the vortex holes, whereby water flows through the vortex holes into the flow guide grooves.

Furthermore, the drive assembly includes a drive motor, and a drive base mounted on the output shaft of the drive motor, with the magnetic drive component mounted on the drive base; and the said bottom base houses a control module and a battery, with the battery electrically connected to the control module and the drive motor electrically connected to the control module; the control module is configured to distribute electrical energy from the battery to the drive motor.

Furthermore, the transmission assembly includes a protective sleeve disposed externally around the magnetic driven component, and the protective sleeve being configured to isolate the magnetic driven component from the water body.

Furthermore, the protective sleeve is made of Teflon material.

Furthermore, the water agitation disc is made of a light-transmitting material, and the water agitation disc is provided with a plurality of annular grooves.

According to some embodiments of the present disclosure, a pet water dispenser is provided, including a bottom base equipped with a drive assembly; the drive assembly includes magnetic drive component; a containment section for holding drinking water, mounted on the bottom base; a water agitation assembly immersed in the drinking water to agitate it; the water agitation assembly includes an agitation base and a water agitation disc, with a magnetic driven component mounted on the agitation base; the drive assembly drives the agitation base to rotate and agitate the water through magnetic force interaction between the magnetic drive component and the magnetic driven component; the water agitation disc is indirectly driven by the water flow generated by the agitation base.

Furthermore, the water agitation disc is provided with a central hole, and the agitation base includes a flow guide section for directing water flow, and the flow guide section is mounted through the central hole, with a gap between the flow guide section and the edge of the central hole for water passage; and the flow guide section is connected to a vortex turntable positioned above the water agitation disc, and is connected to a bottom baffle positioned below the water agitation disc; the vortex turntable rotates to guide the water flow into the flow guide section, which directs the water flow through the central hole to the area below the water agitation disc.

Furthermore, a gap for water flow is provided between the edge of the water agitation disc and the containment section.

Furthermore, the vortex turntable is provided with agitation fin plates for guiding water flow to converge toward the vortex turntable; and
the vortex turntable is provided with vortex holes, and the flow guide section is provided with flow guide grooves corresponding to the vortex holes, whereby water flows through the vortex holes into the flow guide grooves.

According to some embodiments of the present disclosure, a pet water dispenser is provided, including a bottom base featuring a mounting cavity; a drive assembly with a magnetic drive component installed within the mounting cavity; the drive assembly rotates the magnetic drive component when energized; a containment section positioned on the bottom base for holding drinking water; the mounting cavity and the containment section are mutually isolated to prevent contact between the drive assembly and the drinking water within the containment section; a water agitation assembly immersed in the drinking water, including an agitation base for agitating the water body, and the agitation base featuring a magnetic driven component mounted thereon; the drive assembly drives the agitation base to rotate through the magnetic force interaction between the magnetic drive component and the magnetic driven component.

Furthermore, the water agitation assembly further includes a water agitation disc, which is indirectly driven by the water flow driven by the agitation base.

Furthermore, the water agitation disc is provided with a central hole, and the agitation base includes a flow guide section for directing water flow, and the flow guide section is mounted through the central hole, with a gap between the flow guide section and the edge of the central hole for water passage; and the flow guide section is connected to a vortex turntable positioned above the water agitation disc, and is connected to a bottom baffle positioned below the water agitation disc; the vortex turntable rotates to guide the water flow into the flow guide section, which directs the water flow through the central hole to the area below the water agitation disc.

Furthermore, a gap for water flow is provided between the edge of the water agitation disc and the containment section.

Furthermore, the vortex turntable is provided with agitation fin plates for guiding water flow to converge toward the vortex turntable; and the vortex turntable is provided with vortex holes, and the flow guide section is provided with flow guide grooves corresponding to the vortex holes, whereby water flows through the vortex holes into the flow guide grooves.

Furthermore, the water agitation disc is made of a light-transmitting material, and the water agitation disc is provided with a plurality of annular grooves.

### BRIEF DESCRIPTION OF THE DRAWINGS

The accompanying drawings are provided to facilitate further understanding of the present disclosure and form part of the present disclosure. The illustrative embodiments and their descriptions are intended to explain the present disclosure and do not constitute undue limitations thereof. In the drawings:

FIG. 1 is a schematic diagram of the overall structure of the pet water dispenser according to some embodiments;

FIG. 2 is a sectional view of the pet water dispenser according to some embodiments;

FIG. 3 is an exploded view of the pet water dispenser according to some embodiments;

FIG. 4 is an exploded view of the bottom base according to some embodiments, first perspective;

FIG. 5 is an exploded view of the bottom base according to some embodiments, second perspective;

FIG. 6 is a structural schematic diagram of the agitation base according to some embodiments, first perspective;

FIG. 7 is a structural schematic diagram of the agitation base according to some embodiments, second perspective;

FIG. 8 is a sectional view of the transmission assembly according to some embodiments;

FIG. 9 is a schematic diagram of the installation relationship between the containment section and the water agitation assembly according to some embodiments;

FIG. 10 is a schematic diagram of the working principle of the pet water dispenser according to some embodiments.

Reference signs: 1. Bottom Base; 101. Mounting cavity; 11. Mounting seat; 110. Mounting surface; 111. Support surface; 112. Positioning sleeve; 113. Positioning seat; 114. Locking member; 115. Pin seat; 116. Support pad; 12. Cover plate; 120. Upper cover surface; 121. Lower cover surface; 122. Positioning pin; 123. Positioning groove; 13. Control module; 131. Circuit board; 132. Control button; 133. Power interface; 14. Battery; 2. Drive assembly; 21. Drive motor; 22. Drive base; 221. Shaft bore; 222. Mounting slot; 23. Magnetic drive component; 3. Containment section; 301. Containment groove; 302. Connection base; 303. Bottom groove; 304. Bottom side wall; 31. Liner; 311. Inner groove; 312. Inner side wall; 4. Water agitation assembly; 41. Agitation base; 411. Flow guide section; 4111. Flow guide groove; 412. Vortex turntable; 413. Vortex hole; 414. Agitation fin plate; 415. Rib plate; 416. Bottom baffle; 417. Water passage groove; 418. Base bottom surface; 419. Containment cavity; 42. Water agitation disc; 421. Disc top surface; 422. Disc bottom surface; 423. Annular groove; 424. Central hole; 425. Corrugated groove; 426. Ornament; 43. Transmission assembly; 431. Magnetic driven component; 432. Protective sleeve.

### DETAILED DESCRIPTION

To further illustrate the content, features, and efficacy of the present disclosure, the following embodiments are provided and described in detail with reference to the accompanying drawings:

### Embodiment 1

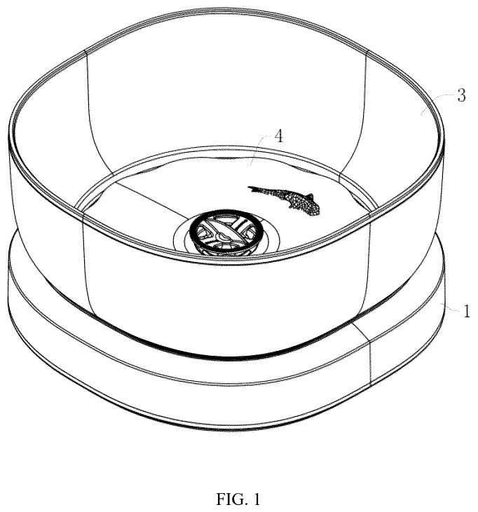

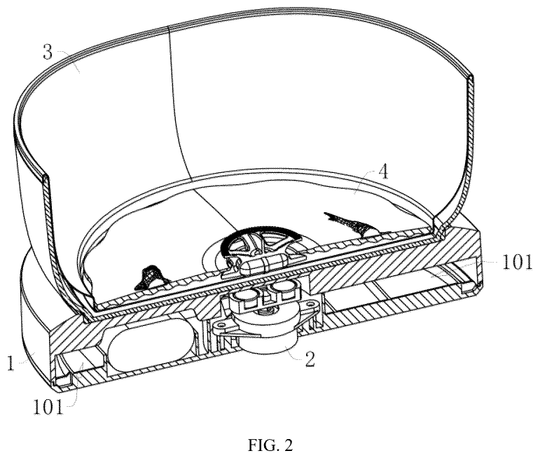

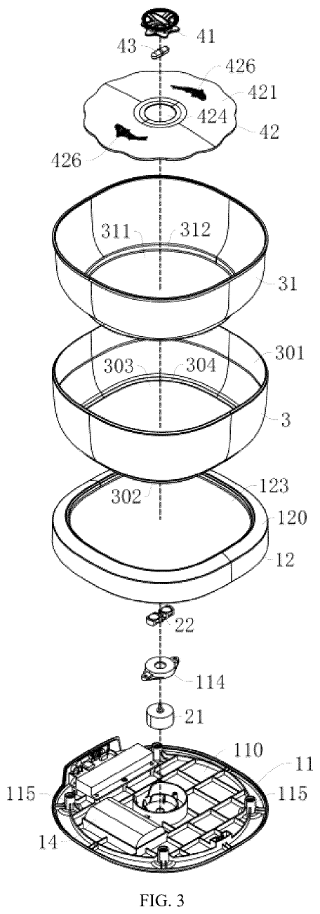

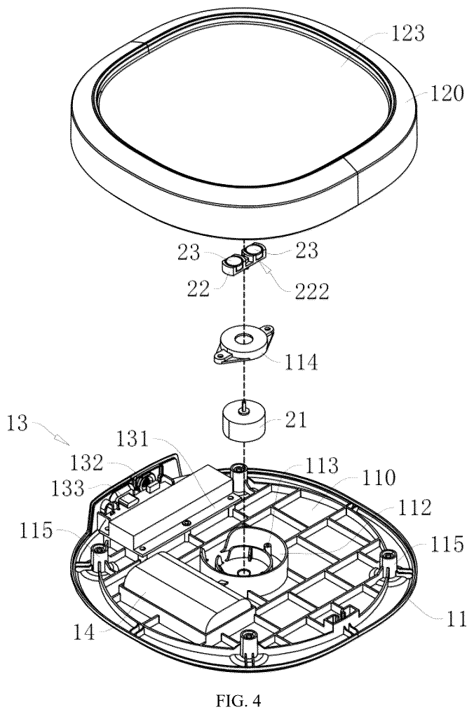

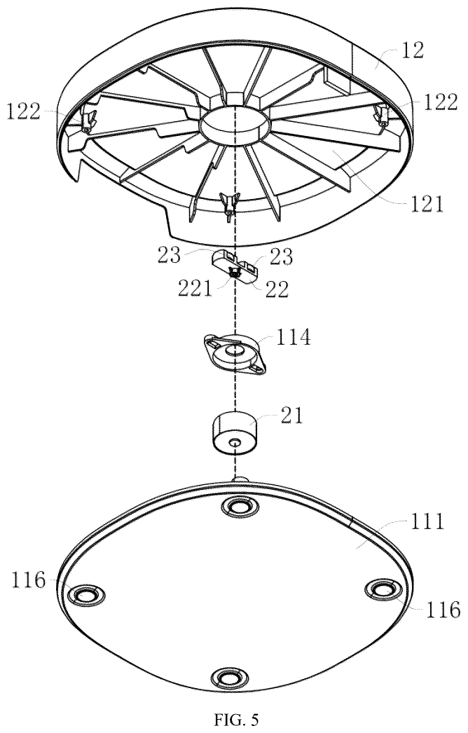

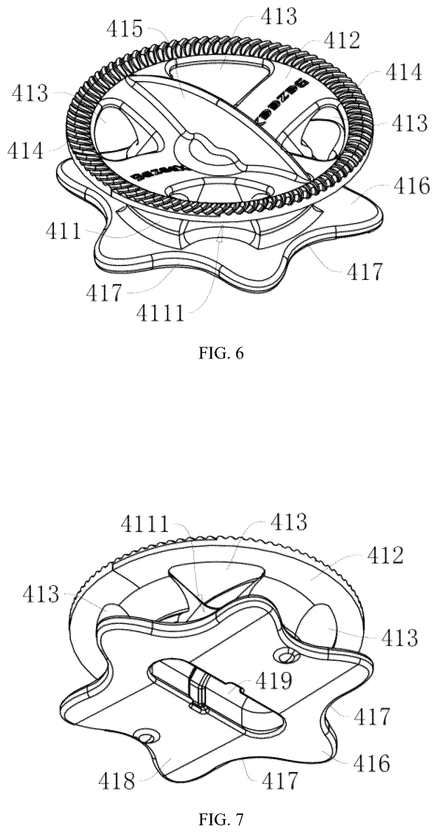

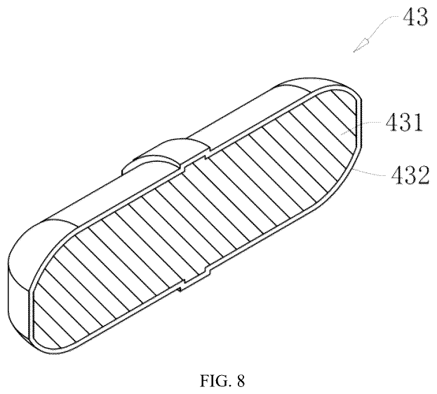

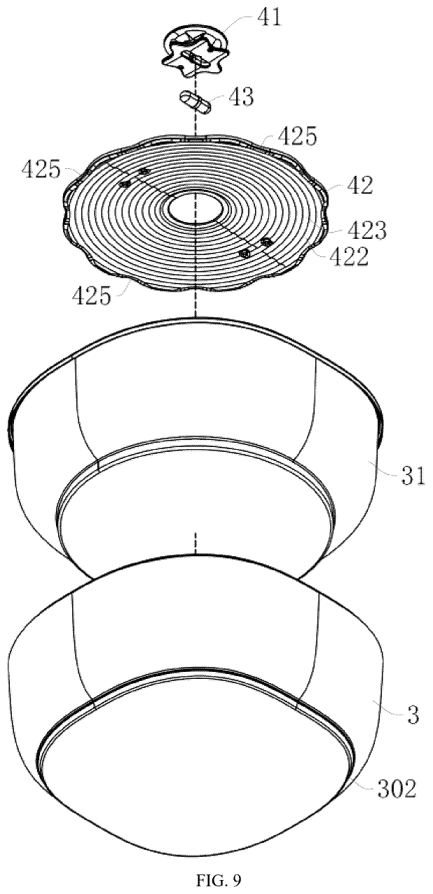

Please refer to FIGS. 1-9. This embodiment discloses a pet water dispenser, including a bottom base 1 that can be placed on the ground or any horizontal surface during use. The bottom base 1 further includes a mounting seat 11 and a cover plate 12 snap-fitted over the mounting seat 11. The mounting seat 11 and cover plate 12 snap together to form a mounting cavity 101 for mounting components. Inside the mounting cavity 101 is a drive assembly 2 that provides the power for agitating water. A containment section 3 for containing drinking water is positioned above the cover plate 12. A water agitation assembly 4 is installed within the containment section 3. When the containment section 3 contains sufficient drinking water, the water agitation assembly 4 is submerged below the water surface. By driving the water agitation assembly 4 through the drive assembly 2, agitation of the water flow can be achieved.

Specifically, both the mounting seat 11 and the cover plate 12 are injection-molded shells. The mounting seat 11 features an upward-facing mounting surface 110 and a downward-facing support surface 111 during use. The mounting surface 110 may adopt any shape; in this embodiment, it is an axially symmetric figure. A positioning sleeve 112 is integrally formed at the geometric center of the mounting surface 110. The positioning sleeve 112 has a circular structure with an upward-facing opening to define the position of the drive assembly 2. The mounting surface 110 inside the positioning sleeve 112 is provided with a plurality of positioning seats 113. The positioning seats 113 have holes for inserting fasteners such as screws. The positioning seats 113 assist in securing the drive assembly 2 when it is installed inside the positioning sleeve 112. The support surface 111 incorporates multiple support pads 116. These support pads 116 feature a circular structure and are manufactured from elastic, flexible material. When the mounting seat 11 is placed on the ground or a horizontal surface, the support pads 116 provide comprehensive support for the mounting seat 11 and the bottom base 1. They also absorb potential impacts, ensuring the product remains stable during operation.

The cover plate 12 features an upper cover surface 120 that faces upward during use and a lower cover surface 121 that faces downward toward the mounting seat 11 during use. The mounting cavity 101 is the space formed between the mounting surface 110 and the lower cover surface 121 when the cover plate 12 snaps onto the mounting seat 11. This mounting cavity 101 spatially isolates the drive assembly 2 from the drinking water within the containment section 3, preventing direct contact between the drinking water and the drive assembly 2. The lower cover surface 121 of the cover plate 12 integrally features multiple positioning pin 122, which are perpendicular to the lower cover surface 121. Correspondingly, the mounting surface 110 is provided with multiple pin seats 115 for inserting the positioning pins 122. When the cover plate 12 is snapped onto the mounting base 11, each positioning pin 122 corresponds to and inserts into a pin seat 115. By installing fasteners such as screws within the pin seats 115, the cover plate 12 can be securely fixed to the mounting seat 11. The upper cover surface 120 of cover plate 12 features an inwardly recessed positioning groove 123 for mounting containment section 3.

The drive assembly 2 includes a drive motor 21 for providing power. This drive motor 21 is mounted within the positioning sleeve 112, with its output shaft oriented upward. A locking member 114 is installed on the drive motor 21 to secure it and firmly lock its position inside the positioning sleeve 112. Specifically, the locking member 114 features a through-hole that aligns with a corresponding hole in the positioning seat 113. By inserting fasteners such as screws into the through-hole of the locking member 114 and the hole in the positioning seat 113, the locking member 114 is securely fastened to the positioning seat 113, thereby locking the position of the drive motor 21 within the positioning seat 113. A drive base 22 is mounted on the output shaft of the drive motor 21. The drive base 22 features an axially symmetric structure with a circular shaft bore 221 formed along its central axis. This shaft bore 221 is interference-fit onto the output shaft of the drive motor 21, enabling the drive base 22 to rotate directly when the drive motor 21 is energized and started. The drive base 22 features upward-opening circular mounting slots 222. Preferably in this embodiment, two mounting slots 222 are provided, symmetrically distributed on both sides of the central axis of the drive base 22. Each mounting slot 222 houses a magnetic drive component 23. This magnetic drive component 23 may be composed of magnetic materials such as iron compounds or neodymium magnets. In this embodiment, the magnetic drive component 23 utilizes a neodymium magnet to transmit power to the water agitation assembly 4.

To enable control of the drive motor 21 and provide a power source for it, a control module 13 and a battery 14 are mounted on the bottom base 1. The control module 13 includes a circuit board 131, a control button 132, and a power interface 133. The control button 132 is electrically connected to the circuit board 131 and partially exposed outside the bottom base 1, allowing users to interact with the circuit board 131 via the control button 132 to control the operation of the drive motor 21. The power interface 133 is electrically connected to the circuit board 131 and partially exposed outside the bottom base 1. The power interface 133 enables users to connect the product to mains power via a power cord, thereby charging the product's energy storage device. In this embodiment, the battery 14 employs a rechargeable lithium battery 14. The battery 14 is electrically connected to the circuit board 131. When the user interacts with the circuit board 131 via the control button 132, the electrical energy within the battery 14 can be distributed to the drive motor 21 under the control of the logic circuit. This causes the drive motor 21 to rotate, providing a power source for the product.

In this embodiment, to prevent energy waste, a radar (not shown in the figure) is mounted on the bottom base 1. The radar may be any device capable of detecting living pets, such as an infrared sensor, microwave sensor, or visual detection device. In this embodiment, the radar employs an infrared sensor; The radar is electrically connected to circuit board 131 and integrated into its logic circuitry. When the infrared sensor detects an approaching pet, circuit board 131 directs power from battery 14 to drive motor 21 for a set duration, activating the drive motor 21. Conversely, when the infrared sensor detects no pet presence, circuit board 131 can, after a preset time, prevent battery 14 power from being allocated to drive motor 21, thereby achieving energy conservation. Additionally, circuit board 131 monitors the operating power of drive motor 21. This power varies with changes in the water level within containment section 3. When the water level in containment section 3 falls below a certain threshold, the operating power of drive motor 21 undergoes a significant change. Based on this feedback, circuit board 131 can control the logic circuit to either prevent power from battery 14 from being allocated to drive motor 21 or allocate it to the drive motor 21 for an extremely brief period. This prevents drive motor 21 from idling and provides the user with feedback indicating insufficient water volume.

The containment section 3 is a container capable of holding drinking water, featuring a containment groove 301 with a semi-open structure. Opposite the opening of the containment groove 301, the bottom of the containment section 3 is equipped with a connection base 302. The connection base 302 protrudes outward from the main body of the containment section 3. During use, the connection base 302 is placed within the positioning groove 123 on the upper cover surface 120 of the cover plate 12, positioning the opening of the containment groove 301 upward. Pets access water from the containment section 3 through the containment groove 301. An inner liner 31 is installed within the containment groove 301. This liner 31 matches the shape of the containment groove 301 and is fixed to the inner side walls of the containment groove 301. It directly holds drinking water and protects the containment section 3. In this embodiment, the inner liner 31 is made of food-grade stainless steel, preventing water contamination while extending service life. To accommodate the water agitation assembly 4, the bottom of the containment groove 301 features a circular bottom groove 303. The bottom groove 303 is recessed inward relative to the bottom of the containment groove 301, forming a bottom side wall 304 that mates with the liner 31. Correspondingly, the bottom of the liner 31 features a circular inner groove 311, which is further recessed inward relative to the bottom of the liner 31, forming an inner side wall 312. The inner groove 311 of the liner 31 is embedded within the bottom groove 303, thereby aligning the inner side wall 312 with the bottom side wall 304. When drinking water is contained within the liner 31, the inner side wall 312 of the liner 31 isolates the drinking water from the bottom side wall 304 of the containment section 3.

The water agitation assembly 4 is fully submerged below the water surface during operation. Specifically, the water agitation assembly 4 includes an agitation base 41 and a water agitation disc 42. The water agitation disc 42 features a circular plate structure and is positioned within the inner groove 311. The outer diameter of the water agitation disc 42 is slightly smaller than the diameter of the inner groove 311, creating a gap between the edge of the water agitation disc 42 and the inner side wall 312 of the inner groove 311. This gap allows water flow to pass through. A central hole 424 is formed at the center of the water agitation disc 42. The agitation base 41 is mounted within the central hole 424. The central hole 424 vertically aligns with the positioning sleeve 112, enabling the drive motor 21 of the drive assembly 2 to precisely align vertically with the central hole 424, thereby facilitating power transmission to the agitation base 41. The surface of the water agitation disc 42 facing the bottom of the bottom groove 303 is the disc bottom surface 422, while the surface facing the exterior of the bottom groove 303 is the disc top surface 421. The disc top surface 421 is provided with an ornament 426, which may be designed in shapes or structures that attract pets. For example, the ornament 426 in this embodiment adopts a goldfish shape to capture pets' attention and stimulate their interest in drinking when the water agitation disc 42 rotates. In this embodiment, the water agitation disc 42 is made of a light-transmitting material. Multiple concentric annular grooves 423 are formed on the disc bottom surface 422. These annular grooves 423 are concave channels. When the water agitation disc 42 rotates, the annular grooves 423 can simulate the appearance of water ripples, further enhancing the attraction effect. Additionally, multiple corrugated grooves 425 are formed along the periphery of the water agitation disc 42. These corrugated grooves 425 feature a concave structure designed to increase the clearance between the water agitation disc's edge and the inner side wall 312 of the inner groove 311. This facilitates unimpeded water flow exchange between the upper and lower regions of the water agitation disc 42, thereby reducing flow resistance and aiding vortex formation. Multiple corrugated grooves 425 are uniformly spaced around the center of the water agitation disc 42, further reducing water resistance.

The agitation base 41 includes an integrally formed flow guide section 411, a vortex turntable 412, and a bottom baffle 416. The flow guide section 411 has an overall cylindrical structure and is mounted within the central hole 424. Its upper and lower ends are positioned on opposite sides of the water agitation disc 42. The vortex turntable 412 is a circular disc mounted at the upper end of the flow guide section 411, while the bottom baffle 416 is a circular plate mounted at the lower end of the flow guide section 411. The maximum outer diameters of both the vortex turntable 412 and the bottom baffle 416 exceed the bore diameter of the central hole 424, enabling the entire agitation base 41 to snap-fit securely within the central hole 424 and prevent disengagement. A clearance exists between the edges of the flow guide section 411 and the central hole 424 to allow water flow passage and ensure non-contact between the agitation base 41 and the water agitation disc 42. The side walls of the flow guide section 411 are provided with a plurality of flow guide grooves 4111. These grooves are recessed channels designed to direct water flow. Correspondingly, the vortex turntable 412 is also provided with a number of vortex holes 413 matching the quantity of the flow guide grooves 4111. The vortex holes 413 penetrate the vortex turntable 412 and correspond one-to-one with the flow guide grooves 4111 vertically. Each flow guide groove 4111 communicates with one vortex hole 413. In this embodiment, four flow guide grooves 4111 and four vortex holes 413 are provided. The four flow guide grooves 4111 are evenly spaced around the central axis of the flow guide section 411 on its side wall, while the four vortex holes 413 are evenly spaced around the central axis of the vortex turntable 412 on its surface. When the agitation base 41 rotates, water flow can enter beneath the vortex turntable 412 through the vortex holes 413. After being guided by the flow guide grooves 4111, the water flows to the underside of the water agitation disc 42. The water flow then further returns to the upper side of the water agitation disc 42 through the gap between the water agitation disc 42 and the bottom side wall 304, thereby forming a circulating flow and inducing a vortex throughout the entire water body.

The upper surface of the vortex turntable 412 is integrally formed with multiple protruding agitation fin plates 414. These agitation fin plates 414 are positioned along the periphery of vortex turntable 412 and distributed on the outer side of vortex holes 413. These multiple agitation fin plates 414 are uniformly spaced around the center of the vortex turntable 412. The agitation fin plates 414 are arcuate in shape. When the agitation base 41 rotates, the agitation fin plates 414 guide the water flow toward the center of the vortex turntable 412, aiding in vortex excitation. An integral rib plate 415 is formed on the upper portion of the vortex turntable 412, positioned parallel to the central axis of the vortex turntable 412. The rib plate 415 serves dual purposes: it propels the water flow forward and facilitates the user's removal of the agitation base 41 and the water agitation disc 42 as a single unit from the water.

The surface of bottom baffle 416 facing the bottom of containment groove 301 forms base bottom surface 418. A containment cavity 419 is formed in base bottom surface 418, which is a long, elongated groove. Both ends of containment cavity 419 feature curved transition structures. A transmission assembly 43 matching the shape of containment cavity 419 is embedded within this cavity. The transmission assembly 43 includes a magnetic driven component 431 and a protective sleeve 432 fitted over the magnetic driven component 431. The magnetic driven component 431 engages with the drive assembly 2 to rotate the agitation base 41. Multiple water passage grooves 417 are formed along the edge of the bottom baffle 416. These grooves adopt a recessed structure to increase the clearance between the bottom baffle 416 and the periphery of the central hole 424. This reduces hydraulic resistance, enabling water flow to smoothly pass from above the water agitation disc 42 to below it during rotation of the agitation base 41. Since the central hole 424 of the water agitation disc 42 and the drive motor 21 are vertically aligned, when the agitation base 41 and water agitation disc 42 are placed within the containment groove 301, the agitation base 41 and the drive base 22 of the drive assembly 2 are vertically aligned. Upon energizing the drive motor 21 to rotate the drive base 22, the magnetic drive component 23 on the drive base 22 magnetically drives the magnetic driven component 431 to rotate. This, in turn, drives the entire agitation base 41 to rotate, achieving the purpose of disturbing the water body and inducing vortex flow through water movement. This method provides greater disturbance to the water flow, features a simple structure, and significantly reduces product failure rates. Additionally, when the agitation base 41 rotates and generates vortices within the water in the containment groove 301, these vortices indirectly drive the water agitation disc 42 to rotate. In the technology disclosed in this embodiment, the drinking water is flowing, and the water agitation disc 42 is also rotating. This significantly enhances the interactivity between the product and the pet, increasing its appeal to the pet and thereby further encouraging the pet to drink water. Furthermore, the protective sleeve 432 is made of low-resistance material. In this embodiment, the protective sleeve 432 is constructed from Teflon material. This Teflon protective sleeve 432 serves two purposes: it isolates the magnetic driven component 431 from the water, preventing water corrosion of the magnetic driven component 431, and it reduces the resistance exerted by the water on the transmission assembly 43 during rotation.

The operating principle and beneficial effects of this embodiment are as follows:

By separating the drive assembly 2 and the driven water agitation assembly 4, and utilizing magnetic interaction for power transmission, this embodiment achieves a simpler mechanical structure. The water flow is completely isolated from the drive assembly 2, virtually eliminating potential damage to the drive assembly 2 and resulting in a lower failure rate. Existing structures that disturb water using methods such as water pumps consume significant energy to generate water flow momentum, yet deliver suboptimal disturbance effects. In contrast, the water agitation assembly 4 of this embodiment directly agitates the water flow via the vortex turntable 412. Numerous structures for disturbing the water flow are arranged on the vortex turntable 412. Compared to existing methods such as pump-driven water diversion, this agitation method reduces energy waste, thereby achieving a greater disturbance amplitude of the water flow and more effectively attracting the pet's attention.

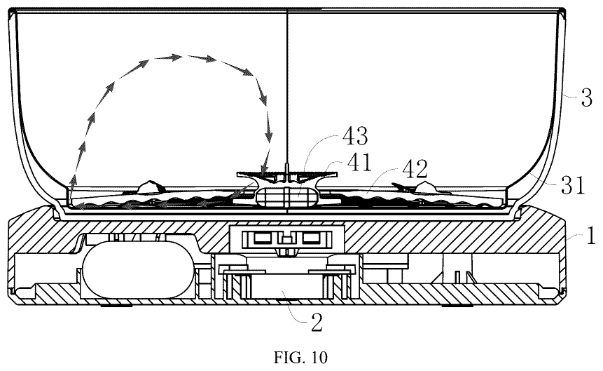

The principle behind vortex formation in the water body of the containment section 3 is as follows: Referring to FIG. 10, The direction indicated by the arrows in the figure represents the water flow direction. When the drive motor 21 is energized, it drives the drive base 22 to rotate. Subsequently, the magnetic drive component 23 on the drive base 22 drives the transmission assembly 43 to rotate via magnetic force. Since the transmission assembly 43 is mounted on the agitation base 41, the agitation base 41 will rotate accordingly under the action of magnetic force. The flow guide grooves 4111 and agitation fin plates 414 on the agitation base 41 stimulate water flow. Water above the water agitation disc 42 enters the vortex turntable 412 through the vortex holes 413. Guided by the flow guide grooves 4111, the water flows through the central hole 424 to the underside of the water agitation disc 42, then flows to the periphery of the water agitation disc 42. Subsequently, it returns to the area above the water agitation disc 42 through the gap between the water agitation disc 42 and the inner side wall 312, forming a circulating flow and generating a vortex within the water body in the containment section 3.

After vortex formation within containment section 3, the water body will rotate, thereby driving the water agitation disc 42 to rotate. The rotation of the water agitation disc 42 further attracts the pet's attention, enhancing interaction between the product and the pet, and consequently encouraging the pet to drink more water.

In summary, the pet water dispenser of this embodiment achieves greater water flow disturbance with a simpler, more reliable mechanical structure and lower failure rate. Additionally, it offers enhanced functionality: beyond water disturbance, features like the water agitation disc 42 improve interaction with pets, increasing appeal and further encouraging water consumption.

The above are merely embodiments of the present disclosure and are not intended to limit the scope of the present disclosure. For those skilled in the art, the present disclosure may be subject to various modifications and variations. Any modifications, equivalent substitutions, improvements, etc., made within the spirit and principles of the present disclosure shall be included within the scope of the appended claims.

What is claimed is:

1. A pet water dispenser, comprising:
a bottom base with a mounting cavity;
a containment section mounted on said bottom base for containing drinking water;
a water agitation assembly, positioned within said containment section and submerged below the water surface;
wherein the mounting cavity houses a drive assembly for driving the water agitation assembly, and the mounting cavity spatially isolates the drive assembly from the drinking water within the containment section.

2. The pet water dispenser according to claim 1, wherein the water agitation assembly comprises an agitation base and a water agitation disc for agitating the water body, and the agitation base is directly driven by the drive assembly to induce water movement, while the water agitation disc is indirectly driven by the water body agitated by the agitation base.

3. The pet water dispenser according to claim 2, wherein the drive assembly comprises a magnetic drive component, and the agitation base is mounted with a transmission assembly, which comprises a magnetic driven component capable of interacting with the magnetic drive component; and
the drive assembly drives the magnetic driven component to move via the magnetic drive component, thereby driving the agitation base.

4. The pet water dispenser according to claim 3, wherein the water agitation disc is provided with a central hole, and the agitation base comprises a flow guide section for directing water flow, and the flow guide section is mounted through the central hole, with a gap between the flow guide section and the edge of the central hole for water passage; and
the flow guide section is connected to a vortex turntable positioned above the water agitation disc, and is connected to a bottom baffle positioned below the water agitation disc, wherein the vortex turntable rotates to guide the water flow into the flow guide section, which directs the water flow through the central hole to the area below the water agitation disc.

5. The pet water dispenser according to claim 4, wherein a gap for water flow is provided between the edge of the water agitation disc and the containment section.

6. The pet water dispenser according to claim 4, wherein the vortex turntable is provided with agitation fin plates for guiding water flow to converge toward the vortex turntable; and
the vortex turntable is provided with vortex holes, and the flow guide section is provided with flow guide grooves corresponding to the vortex holes, whereby water flows through the vortex holes into the flow guide grooves.

7. The pet water dispenser according to claim 3, wherein the drive assembly comprises a drive motor, and a drive base mounted on the output shaft of the drive motor, with the magnetic drive component mounted on the drive base; and
the said bottom base houses a control module and a battery, with the battery electrically connected to the control module and the drive motor electrically connected to the control module, wherein the control module is configured to distribute electrical energy from the battery to the drive motor.

8. The pet water dispenser according to claim 3, wherein the transmission assembly comprises a protective sleeve disposed externally around the magnetic driven component, and the protective sleeve being configured to isolate the magnetic driven component from the water body.

9. The pet water dispenser according to claim 8, wherein the protective sleeve is made of Teflon material.

10. The pet water dispenser according to claim 2, wherein the water agitation disc is made of a light-transmitting material, and the water agitation disc is provided with a plurality of annular grooves.

11. A pet water dispenser, comprising:
a bottom base equipped with a drive assembly, wherein the drive assembly comprises a magnetic drive component;
a containment section for holding drinking water, mounted on the bottom base;
a water agitation assembly immersed in the drinking water to agitate it; wherein the water agitation assembly comprises an agitation base and a water agitation disc, with a magnetic driven component mounted on the agitation base; the drive assembly drives the agitation base to rotate and agitate the water through magnetic force interaction between the magnetic drive component and the magnetic driven component;
the water agitation disc is indirectly driven by the water flow generated by the agitation base.

12. The pet water dispenser according to claim 11, wherein the water agitation disc is provided with a central hole, and the agitation base comprises a flow guide section for directing water flow, and the flow guide section is mounted through the central hole, with a gap between the flow guide section and the edge of the central hole for water passage; and
the flow guide section is connected to a vortex turntable positioned above the water agitation disc, and is connected to a bottom baffle h positioned below the water agitation disc, wherein the vortex turntable rotates to guide the water flow into the flow guide section, which directs the water flow through the central hole to the area below the water agitation disc.

13. The pet water dispenser according to claim 12, wherein a gap for water flow is provided between the edge of the water agitation disc and the containment section.

14. The pet water dispenser according to claim 12, wherein the vortex turntable is provided with agitation fin plates for guiding water flow to converge toward the vortex turntable; and
the vortex turntable is provided with vortex holes, and the flow guide section is provided with flow guide grooves corresponding to the vortex holes, whereby water flows through the vortex holes into the flow guide grooves.

15. A pet water dispenser, comprising:
a bottom base featuring a mounting cavity; a drive assembly with a magnetic drive component installed within the mounting cavity, wherein the drive assembly rotates the magnetic drive component when energized;
a containment section positioned on the bottom base for holding drinking water; the mounting cavity and the containment section are mutually isolated to prevent contact between the drive assembly and the drinking water within the containment section;
a water agitation assembly immersed in the drinking water, comprising an agitation base for agitating the water body, and the agitation base featuring a magnetic driven component mounted thereon, wherein the drive assembly drives the agitation base to rotate through the magnetic force interaction between the magnetic drive component and the magnetic driven component.

16. The pet water dispenser according to claim 15, wherein the water agitation assembly further comprises a water agitation disc, which is indirectly driven by the water flow driven by the agitation base.

17. The pet water dispenser according to claim 16, wherein the water agitation disc is provided with a central hole, and the agitation base comprises a flow guide section for directing water flow, and the flow guide section is mounted through the central hole, with a gap between the flow guide section and the edge of the central hole for water passage; and
the flow guide section is connected to a vortex turntable positioned above the water agitation disc, and is connected to a bottom baffle positioned below the water agitation disc, wherein the vortex turntable rotates to guide the water flow into the flow guide section, which directs the water flow through the central hole to the area below the water agitation disc.

18. The pet water dispenser according to claim 17, wherein a gap for water flow is provided between the edge of the water agitation disc and the containment section.

19. The pet water dispenser according to claim 17, wherein the vortex turntable is provided with agitation fin plates for guiding water flow to converge toward the vortex turntable; and
the vortex turntable is provided with vortex holes, and the flow guide section is provided with flow guide grooves corresponding to the vortex holes, whereby water flows through the vortex holes into the flow guide grooves.

20. The pet water dispenser according to claim 16, wherein the water agitation disc is made of a light-transmitting material, and the water agitation disc is provided with a plurality of annular grooves.
